(19) United States
(12) Patent Application Publication
(10) Pub. No.: US 2008/0304284 A1
(43) Pub. Date: Dec. 11, 2008

(54) LIGHTING DEVICE

(75) Inventors: Huang Chen Guo, Junghe (TW); Ju Yun Hou, Junghe (TW)

Correspondence Address: BAKER & MCKENZIE LLP;PATENT DEPARTMENT, 2001 ROSS AVENUE, SUITE 2300, DALLAS, TX, 75201, US

(73) Assignee: UPEC ELECTRONICS CORP., Junghe (TW)

(21) Appl. No.: 12/117,203

(22) Filed: May 8, 2008

(30) Foreign Application Priority Data
Jun. 11, 2007 (TW) 096209577

(51) Int. Cl. F21V 7/00; F21V 7/04

(52) U.S. Cl. 362/612; 362/297; 362/619

(57) ABSTRACT

A lighting device may include light sources at one or two distal ends; wherein LEDs may be used as a light source. The lighting device may comprise a housing, at least one light-entering plane, at least one light-emitting plane and at least one guiding surface attached to the housing. A plurality of guiding blocks are configured and disposed on the guiding surface, and at least one distal end of the guiding surface is adjacent to the light source such that as light travels into and within the housing, light may be reflected and/or deflected by the guiding blocks and exits the housing via the light emitting plane. The illumination area opposite the light emitting plane may therefore receive substantially uniform lighting from the lighting device. The device may further comprise a reflector covering a portion of the guiding surface and a diffuser covering a portion of the light emitting plane.

### PRIORITY CLAIM

The present disclosure claims the benefit of Taiwan Patent Application No. 096209577, filed on Jun. 11, 2007.

### FIELD OF THE INVENTION

The present invention relates to a lighting device, and specifically, it relates to a structure of the lighting device configured to effectively guide, reflect and/or diffuse light from a light source

### BACKGROUND OF THE INVENTION

Conventional lighting devices generally utilize light guides adopted therein to achieve the guiding of lights to desired areas. However, common lighting devices are designed for a specific light source rather than for different light sources. Furthermore, conventional lighting devices sometimes fail to demonstrate effective lighting by not able to provide uniform lighting to all desired illumination areas. For instance, when a lighting device with concentrated lights is used to light a large area, the design and the configuration of the device would determine if uniform lighting can be achieved across the entire area. There is a need to obtain uniform lighting from a lighting device without changing or re-arranging its light sources, for example the quantities and/or types of the light sources, by providing an improved mechanical structure.

Common light guides are designed to cover the areas where light sources are present. Thus, the structure of the light guides must depend on the shapes, types and designs of the light sources such that proper light guiding effects can be achieved. For example, in some applications where a light source is restricted to a specific location, such as in the distal end of the light guide, there is a need for a structural design capable of effectively directing and guiding the lights from the light source to the desired areas while uniform lighting is achieved.

With regard to the types of light sources, Light Emitting Diode (LED) has been widely adapted in many applications and fields. LED is a semiconductor element which is capable of producing visible lights without generating a great amount of heat and consuming large amount of energy. LED is also known as a “cold light” source and is, in general, of a greater lifetime than conventional lights. Furthermore, LED is also known for its light weight and small size. While having the advantages of being a “cold light” with light weight and small size, LED devices may be designed to include a plurality of LEDs distributed over a particular illuminated area such that uniform and distal lighting can be obtained. For example, in the application where a desired illumination area is much greater than the lighting device disposed thereupon, numerous LEDs must be used to achieve uniform lighting. As shown in FIG. 1, a LED lighting device 100 includes a substrate 110 and a plurality of LEDs 120 provided on said substrate 110. When the illuminated area P is, for instance, an elongated area, LEDs 120 are required to be distributed over said area P such that uniform lighting 122 can be obtained. Such configuration or design is unfavorable as it demands greater number of light sources 120 and can increase the manufacturing and maintenance costs. There is a need to provide a lighting device capable of providing uniform lighting over a desired area while using LED as a source of light.

### SUMMARY OF THE INVENTION

One aspect of the present invention is to provide a lighting device configured to effectively guide or direct lights from a light source therein to desired illumination area.

Another aspect of the present invention is to provide a lighting device configured to guide or direct lights from a light source located at one or more distal ends of the lighting device such that a substantially uniform lighting may be obtained at a desired illumination area.

Still another aspect of the present invention is to provide a lighting device utilizing LED as a light source to achieve a substantially uniform lighting over a desired illumination area while providing a design that can be easily maintained and/or assembled.

According to one embodiment of the present invention, the lighting device comprises: a housing having at least one light entering plane, at least one light emitting plane and at least one guiding surface configured therein; at least one light source located adjacent to the light entering plane of the housing; wherein the light entering plane is provided adjacent to a distal end of the housing such that as the light entered into the housing from said distal end to said guiding surface, the light is directed to the light emitting plane via said guiding surface; and a plurality of guiding blocks provided on said guiding surface are configured to direct the light from the light entering plane to the light emitting plane by ways of reflection and/or deflection such that a substantially uniform lighting in an illuminated area opposite to said light emitting plane is obtained as each unit square of the illuminated area receives substantially the same amount of light.

Furthermore, in another embodiment of the present invention, the lighting device may further comprise at least one reflector on the housing, and the reflector may cover at least a portion of the guiding surface of the housing; preferably, the reflector may cover the guiding surface entirely to enhance the light reflection and/or deflection. In another embodiment, the lighting device may further comprise at least one diffuser on the housing; the diffuser may cover at least a portion of the light emitting plane of the housing; preferably, the diffuser may cover the light emitting plane entirely to enhance the light diffusion therefrom.

According to still another embodiment of the present invention, a lighting device comprises: a housing having at least one light entering plane, at least one light emitting plane and at least one guiding surface configured therein; a plurality of guiding blocks configured on the light guiding surface of the housing; at least one light source positioned adjacent to the light entering plane; at least one reflector covering at least a portion of the guiding surface of the housing; and wherein the light entering plane is located near a distal end of the housing such that the light that enters from the distal end of the housing to the guiding surface is further directed to the light emitting plane via the guiding surface; at least one reflector includes a reflection surface to reflect the light from the light entering plane to the light emitting plane; and wherein the reflector and the plurality of guiding blocks work together to direct the light from the light entering plane to the light emitting plane by ways of reflection and/or deflection such that a substantially uniform lighting in an illuminated area opposite to said light emitting plane is obtained as each unit square of the illuminated area receives substantially the same amount of light. Furthermore, in one embodiment, the lighting device may further comprise at least one diffuser on the housing, and the diffuser may cover at least a portion of the light emitting plane of the housing.

According to still another embodiment of the present invention, a lighting device comprises: a housing having at least one light entering plane, at least one light emitting plane and at least one guiding surface configured therein; a plurality of guiding blocks configured on the light guiding surface of the housing; at least one light source positioned adjacent to the light entering plane; at least one reflector covering at least a portion of the guiding surface of the housing; at least one diffuser covering at least a portion of the light emitting plane; and wherein the light entering plane is located near a distal end of the housing such that the light that enters from the distal end of the housing to the guiding surface is further directed to the light emitting plane via the guiding surface; the reflector includes a reflection surface to reflect the light from the light entering plane to the light emitting plane; wherein the reflector and the plurality of guiding blocks work together to direct the light from the light entering plane to the light emitting plane by ways of reflection and/or deflection; and the diffuser covering at least a portion of the light emitting plane further diffuses the light to the light emitting plane such that a substantially uniform lighting in an illuminated area opposite to the light emitting plane is obtained as each unit square of the illuminated area receives substantially the same amount of light.

Additionally, in any one of the preferred embodiments mentioned, an example of the guiding blocks may protrude outwardly on one side of the guiding surface in the housing. In another embodiment, said plurality of guiding blocks may be formed integrally with the guiding surface of the housing. In a preferred embodiment, the number of said plurality of guiding blocks on the guiding surface may increase as the distance between said plurality of guiding blocks and the light entering plane increase. In another preferred embodiment, the number of said plurality of guiding blocks on the guiding surface decreases as the distance between said plurality of guiding blocks and the light entering plane increase. In one embodiment, said plurality of guiding blocks may be protrusions that are spaced apart and parallel to each other on the guiding surface. Furthermore, said plurality of guiding blocks may also be protruding dots that are spaced apart from each other. In one embodiment, the number of said protruding dots increases uniformly as the distance between said protruding dots and the light entering plane increases.

According to a preferred embodiment of the present invention, at least one light source is being disposed or positioned adjacent to the abovementioned light entering plane of the housing. In one embodiment of the lighting device of the present invention, at least one light source is a LED.

### BRIEF DESCRIPTION OF THE DRAWINGS

FIG. 1 shows a schematic side view of a conventional lighting device;

FIG. 2A shows a perspective view of a lighting device according to a preferred embodiment of the present invention;

FIG. 2B shows a perspective view of a lighting device according to another preferred embodiment of the present invention;

FIG. 2C shows a side view of a lighting device according to a preferred embodiment of the present invention;

FIG. 2D shows a partially enlarged side view of the lighting device of the present invention of FIG. 2C.

FIG. 3 shows a side view of a lighting device according to a preferred embodiment of the present invention;

FIG. 4A shows a perspective view of an embodiment of a plurality of guiding blocks according to the present invention;

FIG. 4B shows a perspective view of another embodiment of a plurality of guiding blocks according to the present invention;

FIG. 4C shows a perspective view of another embodiment of a plurality of guiding blocks according to the present invention;

FIG. 4D shows a perspective view of another embodiment of a plurality of guiding blocks according to the present invention;

FIG. 4E shows a perspective view of another embodiment of a plurality of guiding blocks according to the present invention;

FIG. 4F shows a perspective view of another embodiment of a plurality of guiding blocks according to the present invention;

FIG. 4G shows a perspective view of another embodiment of a plurality of guiding blocks according to the present invention;

FIG. 5A shows a schematic side view of a lighting device according to another preferred embodiment of the present invention;

FIG. 5B shows a schematic side view of a lighting device according to another preferred embodiment of the present invention;

FIG. 6A shows a front view of a lighting device according to another preferred embodiment of the present invention;

FIG. 6B shows a front view of a lighting device according to another preferred embodiment of the present invention;

FIG. 7A shows a schematic side view of a lighting device according to a preferred embodiment of the present invention;

FIG. 7B a schematic side view of a lighting device according to another preferred embodiment of the present invention;

FIG. 8A shows a front view of a lighting device according to a preferred embodiment of the present invention; and

FIG. 8B shows a front view of a lighting device according to another preferred embodiment of the present invention.

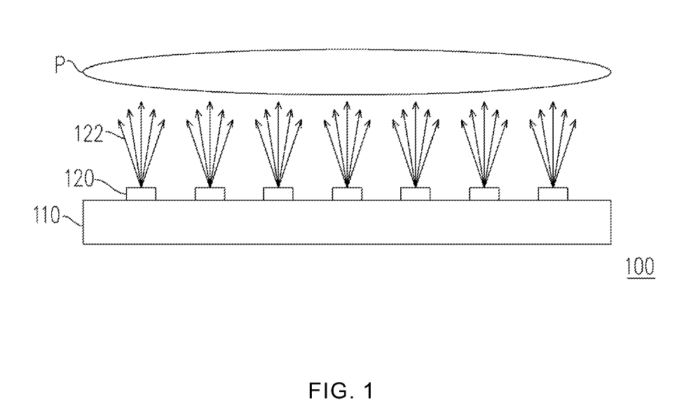

### DESCRIPTION OF EMBODIMENTS OF THE INVENTION

The present invention provides a lighting device capable of effectively guiding and directing lights to desired illumination areas such that uniform lighting can be obtained. The following directs to the details of the present invention and a number of preferred embodiments are also provided for illustrative purposes. Note that the present invention shall not be limited to the embodiments described herein, and other variations or embodiments shall fall within the scope of the present invention.

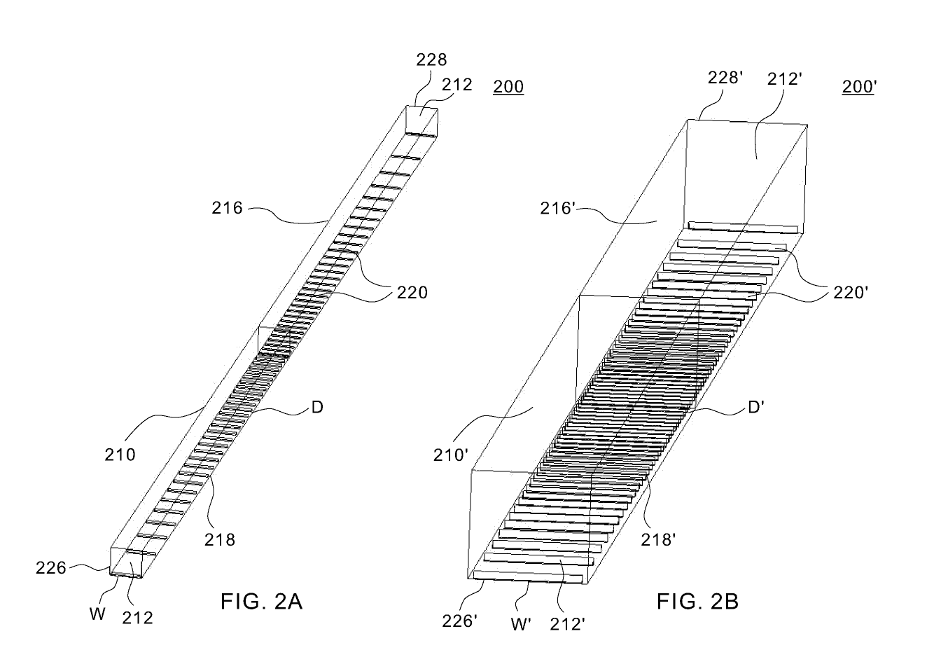

FIGS. 2A˜2D show the perspective and front views of a lighting device according to a preferred embodiment of the present invention. First, in FIG. 2A, a lighting device 200 comprises a housing 210 having a light entering plane 212, a light emitting plane 216 and a guiding surface 218 configured therein. The lighting device 200 includes a plurality of guiding blocks 220 that are configured and disposed on one side of the guiding surface 218. As such, as the light from a light source (not shown) enters the housing 210 from the light entering plane 212, at least a portion of the light reaches the guiding surface 218 and may be further directed or guided by the guiding blocks to exit from the light emitting plane 216. In other words, due to the configuration of the guiding blocks 220 disposed on the guiding surface 218, the light from the light source entering the housing 210 may be effectively directed to the light emitting plane 216 by ways of reflection and/or deflection such that a desired illumination area opposite to the light emitting plane 216 and external to the housing 210 may receive a substantially uniform lighting; or to be more specific, each unit square of the illuminated area may receive substantially the same amount of light.

FIG. 2 shows a schematic view of another preferred embodiment of a lighting device 200′ of the present invention. For illustrative purposes, comparisons to the abovementioned lighting device 200 will be made. The lighting device 200 may include a guiding surface 218 in a substantially elongated column shape with a width W and a length D; in comparison, lighting device 200′ may comprise a guiding surface 218′ having a bulkier shape than guiding surface 218 of FIG. 2A with a width W′ substantially larger than W and D′ shorter than D. In other words, the shape of the lighting device 200 may vary depending on the design purposes and applications. The shapes and sizes of the lighting device 200, 200′ may also vary depending on the illumination areas opposite to the light emitting plane 216, 216′. As an example, a lighting device 200 may provide a substantially uniform lighting to an elongated illumination area while having a guiding surface in a shape corresponding to said illumination area. It can be understood that the guiding surfaces 218, 218′ of the lighting device 200, 200′ are not limited to any specific lengths of D, D′ and/or width W, W′. Other variations are possible to accommodate different illumination areas. In one embodiment as shown in FIG. 2B, the lighting device 200′ comprises a plurality of guiding blocks 220′ configured and disposed on the guiding surface 218′. The number of the guiding blocks 220′ increases as the distance from the light entering plane 212′ increases; in other words, the guiding surface 218′ may have a greater number of guiding blocks 220′ as it moves away from the light entering plane. By such configuration, the light emitting plane 216′ may receive substantially uniform lighting for illumination. Furthermore, different shapes and configurations other than those shown in FIGS. 2A˜2D are also possible. For instance, a light device may be of a shape of cylindrical column, semi-circular column, triangular column, regular or irregular curved structures. Similarly, the lighting device of the present invention is not limited to specific size.

FIGS. 2C and 2D refer to the schematic side views of the abovementioned embodiments as shown in FIGS. 2A and 2B. According to one embodiment, the guiding blocks 220 disposed on the guiding surface 218 in the housing 210 may protrude outwardly on one side of the guiding surface 218.

According to one embodiment of the present invention as shown in FIG. 2A˜2D, the guiding blocks 220 may be formed integrally with the guiding surface 218. To be more specific, during the manufacturing or molding process of the housing 210, the guiding surface 218 of the housing 210 may be formed integrally as a single piece via the processes of, for example, injection molding or composite material heat pressing. The guiding surface 218 and/or guiding blocks 220 can be made from materials including thermal plastics or thermal setting materials (e.g. ABS, PP or PMMA), composite materials, metals or metal alloys that are sufficiently rigid and of great heat resistance. In one embodiment, the housing 210, guiding surface 218 and guiding blocks 220 may all be formed of thermal plastics, thermal setting or composite materials such that all the components can be formed integrally as a single piece via plastic injection moldings or heat pressing. The lighting device 200 may, therefore, be made of materials of great heat resistance and high rigidity to reduce the damage or deformation caused by external forces and to cut down manufacturing costs. Such device may work properly if either the conventional light bulb or LED is used since the materials is of high heat resistance. Note that what are described above are examples only and any other materials capable of providing effective reflection and deflection of lights may be used.

As shown in FIGS. 2A˜2D, the number of the guiding blocks 220 on the guiding surface 218 may increase as the distance between the guiding blocks 218 and the light entering plane 212 increases. With reference to FIG. 2A, in one embodiment, the two distal ends 226, 228 of the lighting device 200 may be adjacent to at least one light source (not shown). As the distance between a guiding block 220 and any one of the distal ends 226, 228 increases, the number of the guiding blocks 220 may too increase to achieve greater reflection and/or deflection of the light from the light source. In another embodiment, each of the distal ends 226, 228 of the lighting device may be disposed of a light source such that the light traveling from the distal ends 226, 228 into the lighting device 220 via the light entering plane 212 is then further directed or guided by the guiding blocks 220 on the guiding surface 218 to ext the housing 210 via the light emitting plane 216. To achieve a substantially uniform lighting by ways of reflection and/or deflection, the number of guiding blocks 220 increases as their distance away from the distal ends 226, 228 increases. To be more specific, as shown in FIGS. 2A and 2B, the number of guiding blocks 220, 220′ disposed near the center area of the guiding surface 218, 218′ are greater than the number of guiding blocks near the distal ends, 226, 226′, 228, 228′. Such configuration may effectively provide a substantially uniform lighting to the light emitting plane 216, 216′ as the reflection and/or deflection of light may be increased as the distance from the light source increases. Similarly, the height H of the guiding blocks 220 may too be arranged to enhance the light reflection and/or deflection towards the light emitting plane 216, 216′ such that a substantially uniform lighting in the area opposite to the light emitting plane 216, 216′ may be achieved. In still another embodiment, the number of guiding blocks on the guiding surface may decrease as the distance between the guiding blocks and the light entering plane increases such that desired illumination effects may be achieved.

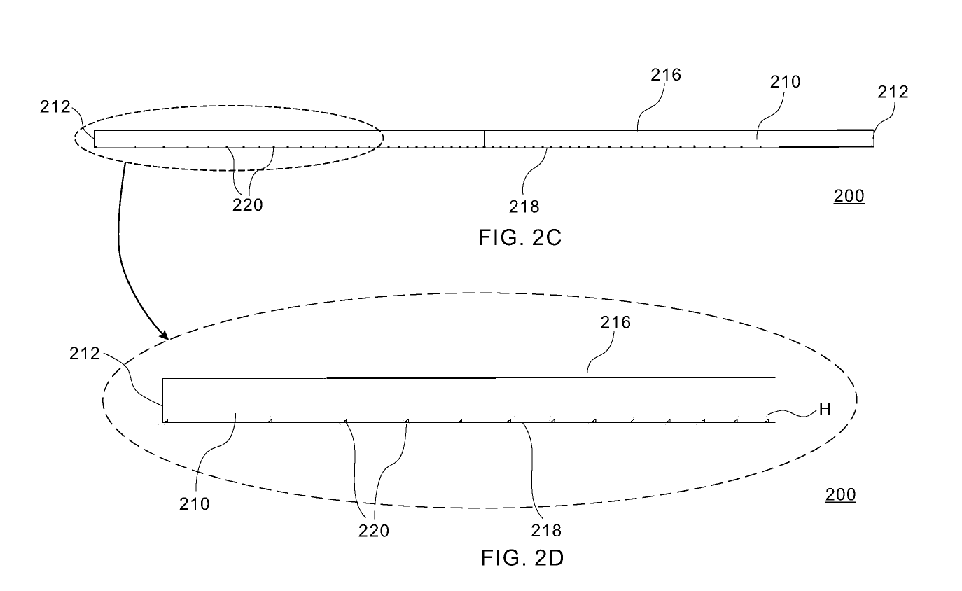

FIG. 3 shows a schematic side view of an embodiment of the lighting device 200. As the light enters the housing 210 from the light source 230, 240 at the distal ends 226, 228, the light rays 232, 242 travel into and within the housing 200 via the light entering plane 212. The light is then further reflected and/or deflected by the guiding blocks 220 disposed on the guiding surface 218 of the housing 210 such that the light is directed or guided to the light emitting plane 216 for a substantially uniform lighting in the illumination area opposite to the light emitting plane 216. In another embodiment, at least one light source 230 or 240 is provided or positioned at either one of the distal end 226 or 228 such that the light rays 232 or 242 may enter into the housing 210 via the light entering plane 212 to the guiding surface 218 from which they are further reflected and/or deflected to the light emitting plane by the guiding blocks 220.

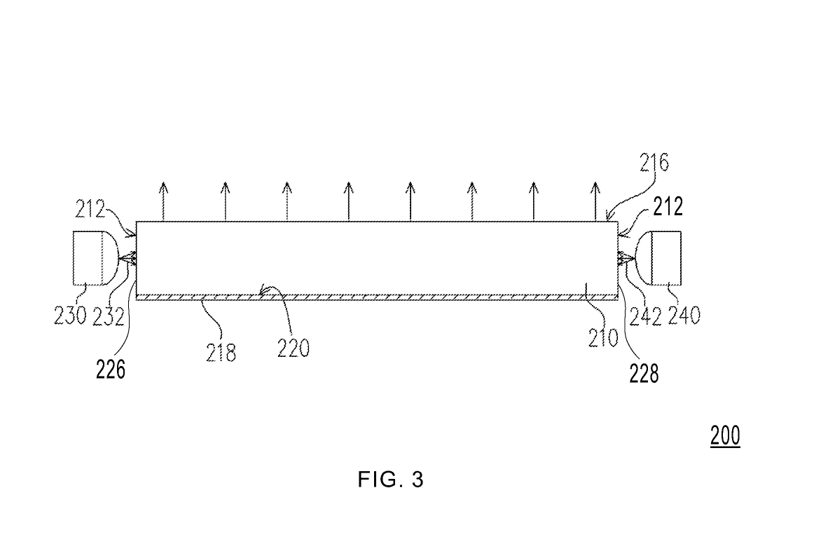

The structural configuration of the guiding blocks 220 may be embodied in numerous forms including micro-structures, linear protrusion or circular dots and bulges. FIGS. 4A˜4G show a number of embodiments of the guiding blocks 220, 220′. With reference to the embodiments shown in FIGS. 4A˜4D, the guiding blocks 220A may be configured and disposed as protrusions which are spaced apart from and parallel to each other on the guiding surface 218A. In another embodiment, the guiding blocks 220B may be formed as protrusions with a substantially-rectangular column shape, whereas the guiding blocks 220C may be protrusions with a substantially semi-circular column shape. And the guiding blocks 220D may be formed of substantially triangular columns. The embodiments and the shapes described herein are examples for illustrative purposes only and other shapes or configurations are also possible. Furthermore, as previously mentioned, the number of the guiding blocks may also be increased or decreased according to their distance from the distal ends of the lighting device. FIGS. 4E˜4G direct to the configurations of dotted structure of the guiding blocks 220, 220′. As shown in FIG. 4E, the guiding blocks 220E may be formed of a plurality of uniformly distributed dots protruding outwardly on one side of the guiding surface 218E with a substantially equal spacing between adjacent dots. FIG. 4F shows another embodiment of the guiding blocks 220F that are in the form of circular dots arranged in rows and spaced apart from each other; wherein the spacing between the rows of the dots may either increase or decrease uniformly depending on their distance from the distal ends of the lighting device. Moreover, FIG. 4G shows another embodiment of the guiding blocks 220G, in which the guiding blocks 220G in a form of protruding dots may be disposed or configured randomly across the guiding surface 218G. Other configurations or variations of the shapes of guiding blocks are also possible.

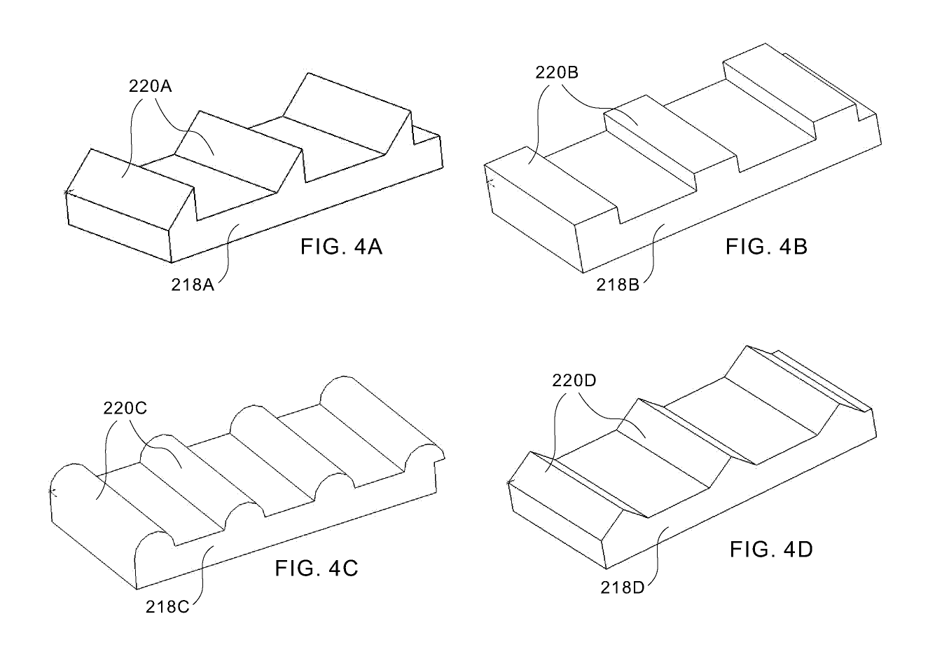

FIGS. 5A and 5B shows another embodiment of the present invention. In one embodiment, the lighting device 300, 300′ differs from the abovementioned embodiments in that the lighting device 300, 300′ may further comprise a reflector 360, 360′. As shown in the accompanied drawings, the reflector 360, 360′ may be attached to either a portion of an external or internal of the housing 310, 310′; said attachment may be achieved by, for example, adhesives, mechanical press-fittings, fixations by fasteners or thermal bonding. The reflector 360, 360′ may include a reflection surface 362, 362′, facing towards the internal of the housing 310, 310′ to facilitate the light from the light sources 330, 340 or 330′ entering into the housing 310, 310′ via the light entering plane 312, 312′ to be directed or guided to the light emitting plane 316, 316′. Furthermore, the reflector 360, 360′ and the guiding blocks 318, 318′ may work or function as one to direct and guide the lights from the light entering plane 312, 312′ to the light emitting plane 316, 316′ by ways of reflection and/or deflection such that a substantially uniform lighting in an illuminated area opposite to said light emitting plane 316, 316′ may be obtained as each unit square of the illuminated area receives substantially the same amount of light. Light sources may be disposed or positioned at either one or two ends of the lighting device. For instance, a comparison between the lighting device 300 shown in FIG. 5A and the lighting device 300′ in FIG. 5B shows that either two light sources 330, 340 may be used and disposed at both distal ends of the lighting device 300, or a single light source 330′ may be adapted at one end only. It is clear that other variations or embodiments are possible to those skilled in the art.

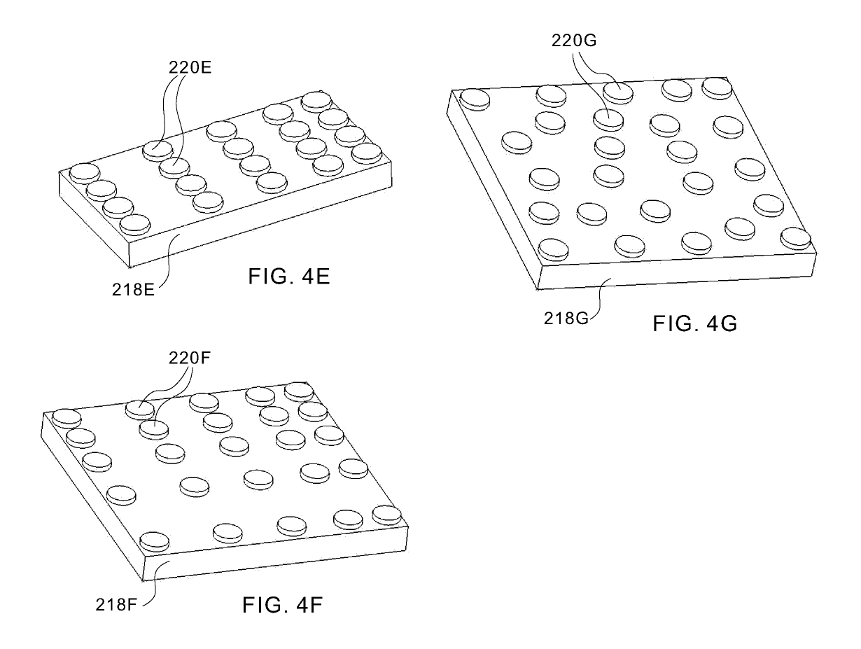

FIGS. 6A and 6B show different embodiments of the reflector 360. The reflector 360A, 360B may cover a portion of the guiding surface 318 such that the light in the housing 310 may be reflected to the external of the housing 310 via the light emitting plane 316; preferably, the reflector 360A, 360B may cover the guiding surface entirely to enhance the light reflection and/or deflection. The reflector 360A, 360B may be formed of any material capable of reflecting lights, such as metals, alloys, materials with polished surfaces, plastics or composites with coated surfaces for light reflection.

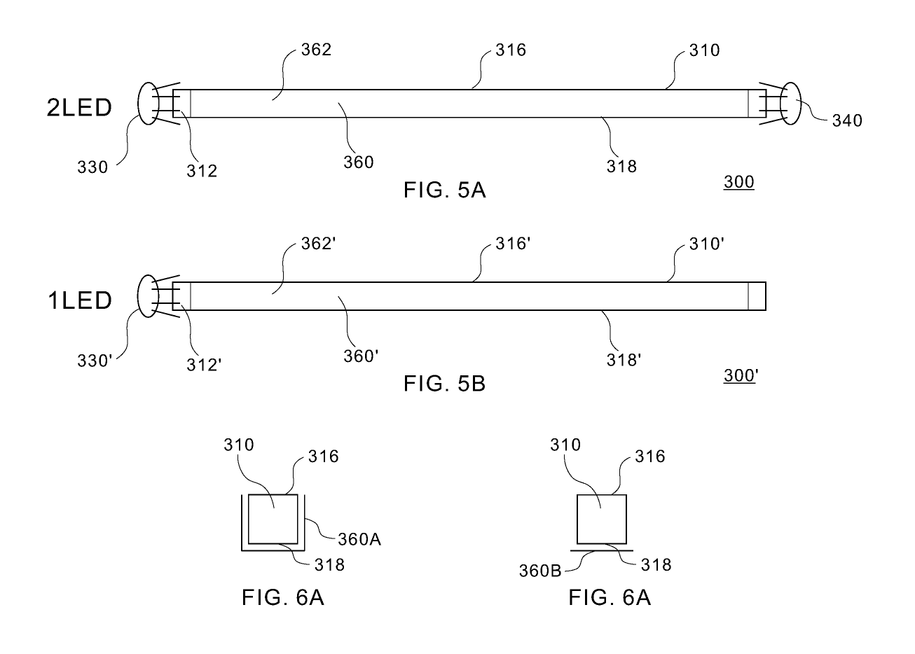

With reference to FIGS. 7A and 7B, the lighting device 400, 400′ is disclosed. The lighting device 400, 400′ may differ from the abovementioned embodiments in that it may comprise a diffuser 480, 480′ in addition to the reflector 460, 460′ with a reflection surface 462, 462′. The diffuser 480, 480′ may be attached to the housing 410, 410′ and may cover at least a portion of the light emitting plane 416, 416′; wherein said attachment may be achieved by adhesives, mechanical press-fitting, fixations by fasteners or thermal bonding. Preferably, the diffuser 480, 480′ may cover the light emitting plane 416, 416′ entirely to enhance the light diffusion therefrom. The diffuser 480, 480′ may also include a light diffusing surface 482, 482′ such that the light traveling into and within the housing 410, 410′ may be further diffused upon its emission to the external via the light emitting plane 416, 416′. Similarly, the light source of the lighting device 400, 400′ may be disposed or positioned at either one or two distal ends. For example, in one embodiment, the lighting device 400 may include light sources 430 and 440 disposed respectively at each of the two distal ends; whereas in another embodiment the lighting device 400′ may be disposed of a single light source 410′ on either one of the distal ends. Note that other variations or embodiments are also possible to those skilled in the art.

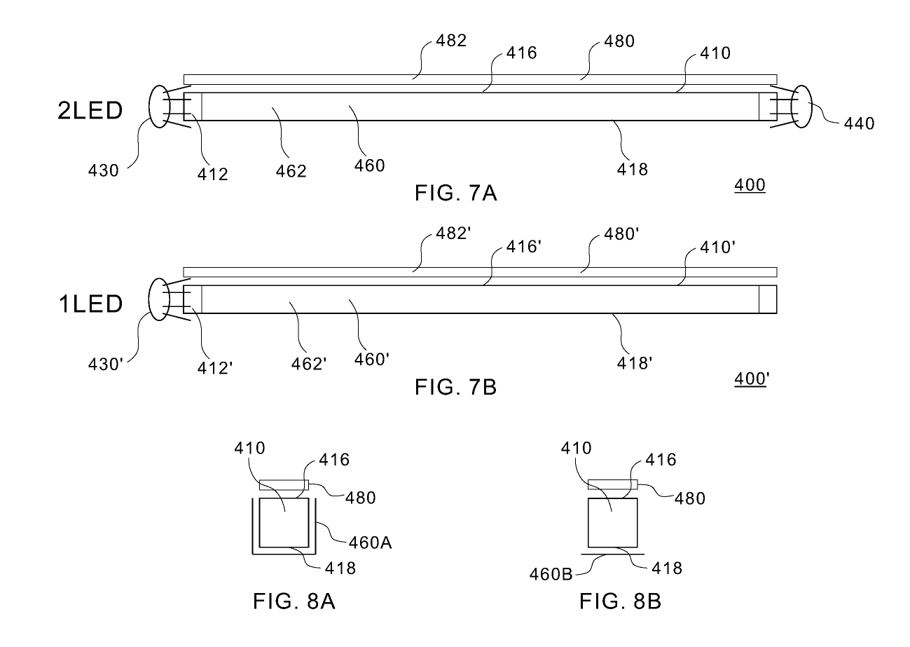

Likewise, FIGS. 8A and 8B refer to the embodiments of the lighting device comprising both a reflector 460A, 460B and a diffuser 480. As shown in the figures, the reflector 460A, 460B may cover at least a portion of the guiding surface 418 such that the light in the housing 410 may be reflected to the external of the housing 410 via the light emitting plane 416. Preferably, the reflector 460A, 460B may cover the guiding surface entirely to enhance the light reflection and/or deflection thereof. Furthermore, the diffuser 480 may cover a portion of the light emitting plane 416 such that the light may be further diffused upon exiting the light emitting plane 416. Preferably, the diffuser 480 may cover the light emitting plane entirely to enhance the light diffusion therefrom and to enhance the uniform lighting in the illuminated area opposite to the light emitting plane 416 as each unit square of the illuminated area receives substantially the same amount of light.

While the present invention is disclosed in reference to the preferred embodiments or examples detailed above, it is to be understood that these embodiments or examples are intended for illustrative purposes only and shall not be treated as limitations of the present invention. Furthermore, the term “a”, “an” or “one” recited above and in the claims is of the meaning equivalent to “at least one”. It is contemplated that modifications and combinations will readily occur to those skilled in the art, which modifications and combinations will be within the spirit of the invention and the scope of the following claims.

What is claimed is:

1. A lighting device, comprising:
a housing having at least one light entering plane, at least one light emitting plane and at least one guiding surface configured therein;
a plurality of guiding blocks configured on the light guiding surface of the housing;
at least one light source positioned adjacent to the light entering plane; and
wherein the light entering plane is located near a distal end of the housing such that the light that enters from the distal end of the housing to the guiding surface is further directed to the light emitting plane via the guiding surface; and wherein the plurality of guiding blocks is configured to direct the lights from the light entering plane to the light emitting plane by ways of reflection and/or deflection such that a substantially uniform lighting in an illuminated area opposite to the light emitting plane is obtained as each unit square of the illuminated area receives substantially the same amount of light.

2. The lighting device according to claim 1, wherein the plurality of guiding blocks protrudes outwardly on one side of the guiding surface.

3. The lighting device according to claim 1, wherein the plurality of guiding blocks is formed integrally with the guiding surface.

4. The lighting device according to claim 1, wherein the number of the plurality of guiding blocks on the guiding surface increases as the distance between the plurality of guiding blocks and the light entering plane increases.

5. The lighting device according to claim 1, wherein the number of the plurality of guiding blocks on the guiding surface decreases as the distance between the plurality of guiding blocks and the light entering plane increases.

6. The lighting device according to claim 1, wherein the plurality of guiding blocks is arranged randomly on the guiding surface.

7. The lighting device according to claim 1, wherein the plurality of guiding blocks is protrusions which are spaced apart and parallel to each other on the guiding surface.

8. The lighting device according to claim 1, wherein the plurality of guiding blocks is protruding dots spaced apart from each other.

9. The lighting device according to claim 8, wherein the number of the protruding dots increases uniformly as the distance between the protruding dots and the light entering plane increases.

10. The lighting device according to claim 1, wherein the light source is a LED.

11. The lighting device according to claim 1, further comprises at least one reflector on the housing, covering at least a portion of the guiding surface of the housing.

12. The lighting device according to claim 11, further comprises at least one diffuser on the housing, covering at least a portion of the light emitting plane of the housing.

13. A lighting device, comprising:
a housing having at least one light entering plane, at least one light emitting plane and at least one guiding surface configured therein;
a plurality of guiding blocks configured on the light guiding surface of the housing;
at least one light source positioned adjacent to the light entering plane;
at least one reflector covering at least a portion of the guiding surface of the housing; and
wherein the light entering plane is located near a distal end of the housing such that the light that enters from the distal end of the housing to the guiding surface is further directed to the light emitting plane via the guiding surface; the reflector includes a reflection surface to reflect the light from the light entering plane to the light emitting plane; and wherein the reflector and the plurality of guiding blocks work together to direct the lights from the light entering plane to the light emitting plane by ways of reflection and/or deflection such that a substantially uniform lighting in an illuminated area opposite to the light emitting plane is obtained as each unit square of the illuminated area receives substantially the same amount of light.

14. The lighting device according to claim 13, wherein the plurality of guiding blocks protrudes outwardly on one side of the guiding surface.

15. The lighting device according to claim 13, wherein the plurality of guiding blocks is formed integrally with the guiding surface.

16. The lighting device according to claim 13, wherein the number of the plurality of guiding blocks on the guiding surface increases as the distance between the plurality of guiding blocks and the light entering plane increases.

17. The lighting device according to claim 13, wherein the number of the plurality of guiding blocks on the guiding surface decreases as the distance between the plurality of guiding blocks and the light entering plane increases.

18. The lighting device according to claim 13, wherein the plurality of guiding blocks is arranged randomly on the guiding surface.

19. The lighting device according to claim 13, wherein the plurality of guiding blocks is protrusions which are spaced apart and parallel to each other on the guiding surface.

20. The lighting device according to claim 13, wherein the plurality of guiding blocks is protruding dots spaced apart from each other.

21. The lighting device according to claim 20, wherein the number of the protruding dots increases uniformly as the distance between the protruding dots and the light entering plane increases.

22. The lighting device according to claim 13, wherein the light source is a LED.

23. The lighting device according to claim 13, further comprises at least one diffuser on the housing, covering at least a portion of the light emitting plane of the housing.

24. A lighting device, comprising:
a housing having at least one light entering plane, at least one light emitting plane and at least one guiding surface configured therein;
a plurality of guiding blocks configured on the light guiding surface of the housing;
at least one light source positioned adjacent to the light entering plane;
at least one reflector covering at least a portion of the guiding surface of the housing;
at least one diffuser covering at least a portion of the light emitting plane; and
wherein the light entering plane is located near a distal end of the housing such that the light that enters from the distal end of the housing to the guiding surface is further directed to the light emitting plane via the guiding surface; the reflector includes a reflection surface to reflect the light from the light entering plane to the light emitting plane; wherein the reflector and the plurality of guiding blocks work together to direct the lights from the light entering plane to the light emitting plane by ways of reflection and/or deflection; and the diffuser covering at least a portion of the light emitting plane further diffuses the light to the light emitting plane such that a substantially uniform lighting in an illuminated area opposite to the light emitting plane is obtained as each unit square of the illuminated area receives substantially the same amount of light.

25. The lighting device according to claim 24, wherein the plurality of guiding blocks protrude outwardly on one side of the guiding surface.

26. The lighting device according to claim 24, wherein the plurality of guiding blocks is formed integrally with the guiding surface of the housing.

27. The lighting device according to claim 24, wherein the number of the plurality of guiding blocks on the guiding surface increases as the distance between the plurality of guiding blocks and the light entering plane increases.

28. The lighting device according to claim 24, wherein the plurality of guiding blocks is protrusions which are spaced apart and parallel to each other on the guiding surface.

29. The lighting device according to claim 24, wherein the plurality of guiding blocks is protruding dots spaced apart from each other.

30. The lighting device according to claim 29, wherein the number of the protruding dots increases uniformly as the distance between the protruding dots and the light entering plane increases.

31. The lighting device according to claim 24, wherein the number of the plurality of guiding blocks on the guiding surface decreases as the distance between the plurality of guiding blocks and the light entering plane increases.

32. The lighting device according to claim 24, wherein the plurality of guiding blocks is arranged randomly on the guiding surface.

33. The lighting device according to claim 24, wherein the light source is a LED.
